(19) United States
(12) Patent Application Publication
(10) Pub. No.: US 2015/0222118 A1
(43) Pub. Date: Aug. 6, 2015

(54) POWER TRANSMISSION AND DISTRIBUTION SYSTEM, CONTROLLER, ROUTER, POWER TRANSMISSION AND DISTRIBUTION METHOD, AND NON-TRANSITORY COMPUTER READABLE MEDIUM STORING PROGRAM

(71) Applicant: NEC CORPORATION, Tokyo (JP)

(72) Inventor: Takuma Kogo, Tokyo (JP)

(21) Appl. No.: 14/428,100

(22) PCT Filed: May 23, 2013
(86) PCT No.: PCT/JP2013/003281

§ 371 Date: Mar. 13, 2015

(30) Foreign Application Priority Data
Sep. 14, 2012 (JP) 2012-202915

(51) Int. Cl. H02J 3/00; G05B 15/02

(52) U.S. Cl. CPC H02J 3/005; G05B 15/02

(57) ABSTRACT

A controller has: risk information acquisition means for acquiring risk information on a power transmission and distribution section formed by two power routers being connected to each other; and control instruction means for calculating a risk score of the power transmission and distribution section based on the risk information, deciding a power transmission and distribution route including the one or more power transmission and distribution sections based on the risk score, and transmitting a control instruction based on the power transmission and distribution route to the power router. The power router has: transmitting and receiving means for outputting input electric power to the one or more power transmission and distribution sections; and transmitting and receiving control means for controlling the output of the transmitting and receiving means according to the control instruction.

### TECHNICAL FIELD

The present invention relates to a power transmission and distribution system, a controller, a router, a power transmission and distribution method, and a non-transitory computer readable medium storing a program and, for example, to a power transmission and distribution technology that can suppress a risk of power outage due to a fault.

### BACKGROUND ART

It is a socially and economically important mission for power companies to continuously supply electric power. In order to achieve the mission, it is important to suppress a risk of an electric accident (fault) in power transmission and distribution as much as possible.

Faults mostly occur in a power distribution network. In addition, occurrence of the faults is mostly caused by a natural disaster and insufficient maintenance. Specifically, transmission line failure, equipment failure, etc. due to lightning strike and a rainstorm, or natural deterioration and insufficient maintenance are main causes of the faults. Consequently, it is required to previously avoid the faults caused by the above as much as possible.

A power transmission and distribution system that prevents power outage due to lightning is described in Patent Literature 1. The power transmission and distribution system first receives weather information to predict a lightning strike forecast range, and specifies power transmission and distribution lines for which lightning strike is forecast. Next, a power transmission and distribution line whose use should be actually stopped is decided based on lightning shielding levels etc. of the power transmission and distribution lines for which the lightning strike is forecast. Power transmission and distribution by the power transmission and distribution line is then stopped by a breaker.

### CITATION LIST

### Patent Literature

Patent Literature 1: Japanese Unexamined Patent Application Publication No. 2009-044917

### SUMMARY OF INVENTION

### Technical Problem

However, the power transmission and distribution system described in Patent Literature 1 has a problem that route calculation for suppressing a risk of lightning strike cannot be appropriately performed when a probability of lightning strike not less than a certain level is predicted in a wide area.

In addition, in the above-described system, power transmission and distribution routes are switched by opening and closing of the breakers, and thus when a certain power transmission and distribution route is broken, all electric power is detoured to an alternative power transmission and distribution route. Therefore, flexible route setting, for example, in which electric power is appropriately distributed into a plurality of power transmission and distribution routes according to a risk of lightning strike of each of the plurality of routes, cannot be performed.

The present invention has been made to solve such problems, and an object thereof is to provide a power transmission and distribution system, a power transmission and distribution method, a router, and a non-transitory computer readable medium storing a program that can suppress a risk of power outage due to a fault.

### Solution to Problem

A power transmission and distribution system according to the present invention is the power transmission and distribution system including: a plurality of power routers that can output input electric power to one or more designated output destinations just as much as designated electric power, respectively; and a controller that controls the power routers, wherein the controller has: risk information acquisition means for acquiring risk information on a power transmission and distribution section formed by the two power routers being connected to each other; and control instruction means for calculating a risk score of the power transmission and distribution section based on the risk information, deciding a power transmission and distribution route including the one or more power transmission and distribution sections based on the risk score, and transmitting a control instruction based on the power transmission and distribution route to the power router, and the power router has: transmitting and receiving means for outputting input electric power to the one or more power transmission and distribution sections; and transmitting and receiving control means for controlling the output of the transmitting and receiving means according to the control instruction.

A controller according to the present invention controls a plurality of power routers that can output input electric power to one or more designated output destinations just as much as designated electric power, respectively, wherein the controller has: risk information acquisition means for acquiring risk information on a power transmission and distribution section formed by the two power routers being connected to each other; and control instruction means for calculating a risk score of the power transmission and distribution section based on the risk information, deciding a power transmission and distribution route including the one or more power transmission and distribution sections based on the risk score, and transmitting a control instruction based on the power transmission and distribution route to the power router.

A power router according to the present invention can output input electric power to one or more designated output destinations just as much as designated electric power, respectively, the power router comprising: transmitting and receiving means for outputting input electric power to the one or more power transmission and distribution sections; and transmitting and receiving control means for receiving a control instruction from a controller and controlling the output of the transmitting and receiving means, wherein the control instruction is generated by the controller based on a power transmission and distribution route, after the controller: acquires risk information on a power transmission and distribution section formed by the two power routers being connected to each other; calculates a risk score of the power transmission and distribution section based on the risk information; and decides the power transmission and distribution route including the one or more power transmission and distribution sections based on the risk score.

A power transmission and distribution method according to the present invention is the method including: a risk information acquisition step in which a controller acquires risk information on a power transmission and distribution section formed by the two power routers being connected to each other; a risk score calculation step in which the controller calculates a risk score of the power transmission and distribution section based on the risk information; a power transmission and distribution route decision step in which the controller decides a power transmission and distribution route including the one or more power transmission and distribution sections based on the risk score; a control instruction step in which the controller transmits a control instruction based on the power transmission and distribution route to the power router; and a transmitting and receiving step in which the power router outputs electric power input to the power router to the one or more designated power transmission and distribution sections just as much as designated electric power according to the control instruction, respectively.

A non-transitory computer readable medium storing a program according to the present invention makes a computer execute: a risk information acquisition step of acquiring risk information on a power transmission and distribution section formed by the two power routers being connected to each other; a risk score calculation step of calculating a risk score of the power transmission and distribution section based on the risk information; a power transmission and distribution route decision step of deciding a power transmission and distribution route including the one or more power transmission and distribution sections based on the risk score; a control instruction step of generating a control instruction based on the power transmission and distribution route; and a transmitting and receiving step of outputting electric power input to the power router to the one or more designated power transmission and distribution sections just as much as designated electric power according to the control instruction, respectively.

A non-transitory computer readable medium storing a program according to the present invention makes a computer execute: a risk information acquisition step of acquiring risk information on a power transmission and distribution section formed by the two power routers being connected to each other; a risk score calculation step of calculating a risk score of the power transmission and distribution section based on the risk information; a power transmission and distribution route decision step of deciding a power transmission and distribution route including the one or more power transmission and distribution sections based on the risk score; and a control instruction step of generating a control instruction based on the power transmission and distribution route.

A non-transitory computer readable medium storing a program according to the present invention makes a computer execute: a step of receiving from a controller a control instruction generated by the controller based on a power transmission and distribution route, after the controller acquires risk information on a power transmission and distribution section formed by the two power routers being connected to each other, calculates a risk score of the power transmission and distribution section based on the risk information, and decides the power transmission and distribution route including the one or more power transmission and distribution sections based on the risk score; and a transmitting and receiving step of outputting input electric power to the one or more designated power transmission and distribution sections just as much as designated electric power according to the control instruction, respectively.

### Advantageous Effects of Invention

According to the present invention, there can be provided the power transmission and distribution system, the controller, the router, the power transmission and distribution method, and the non-transitory computer readable medium storing the program that can suppress a risk of power outage due to a fault.

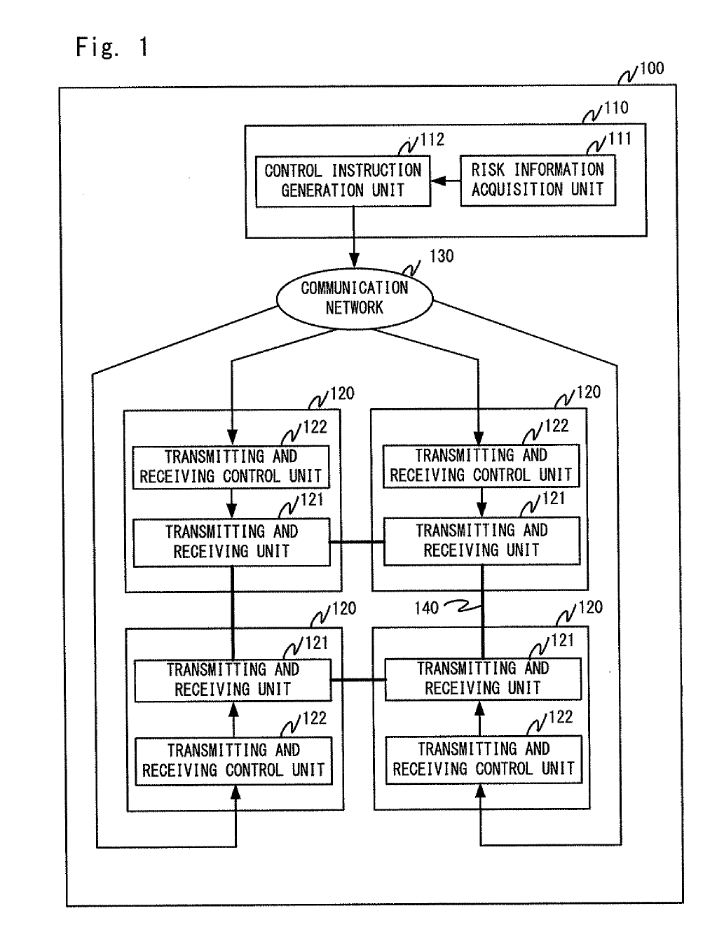

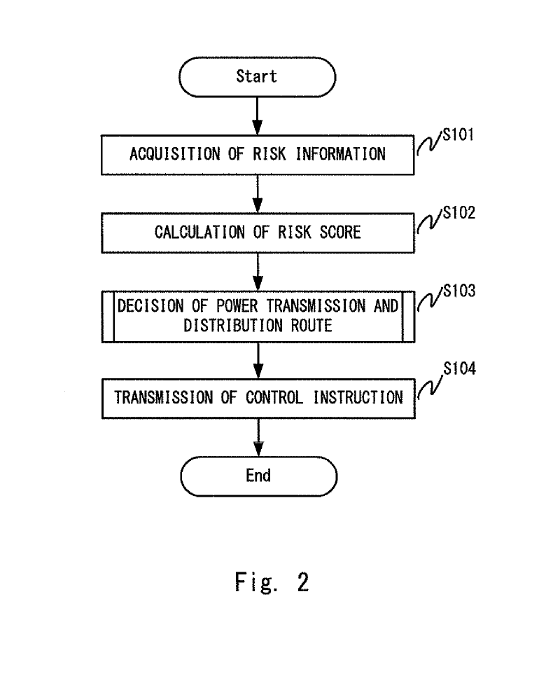

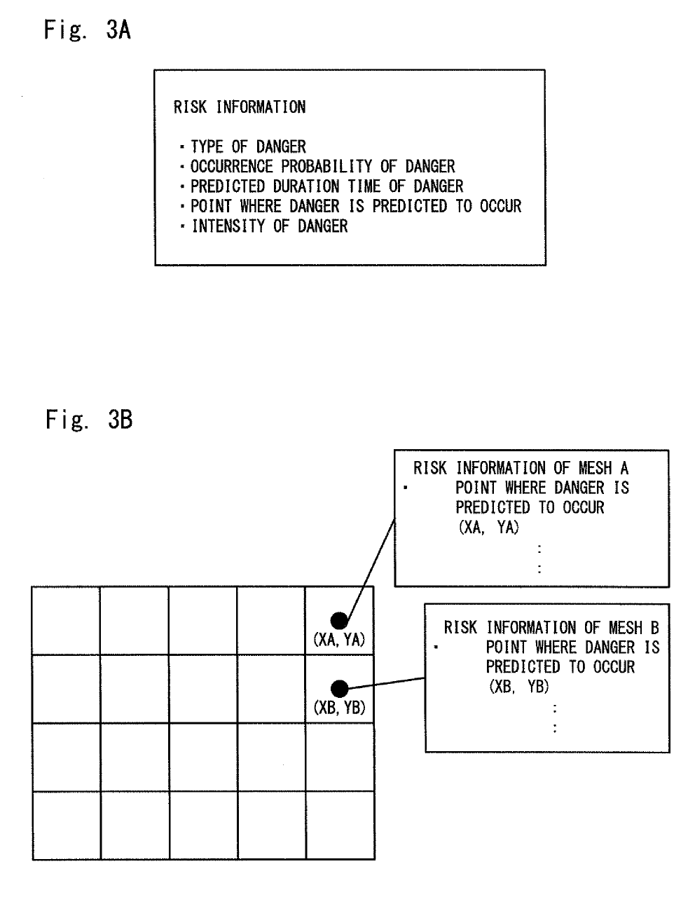

### BRIEF DESCRIPTION OF DRAWINGS

[FIG. 1] FIG. 1 is a diagram showing a configuration of a power transmission and distribution system 100 according to an embodiment 1.

[FIG. 2] FIG. 2 is a flow chart showing processing of the power transmission and distribution system 100 according to the embodiment 1.

[FIG. 3A] FIG. 3A is an illustration showing one example of risk information according to the embodiment 1.

[FIG. 3B] FIG. 3B is an illustration showing one example of risk information according to the embodiment 1.

### DESCRIPTION OF EMBODIMENTS

Hereinafter, specific embodiments to which the present invention has been applied will be explained in detail with reference to drawings.

### Embodiment 1

First, a configuration of a power transmission and distribution system 100 according to an embodiment 1 will be explained using FIG. 1. Note that arrows of narrow lines in FIG. 1 represent a flow of data, and that arrows of bold lines represent a flow of electric power.

The power transmission and distribution system 100 has a controller 110 and a plurality of power routers 120. The controller 110 and each power router 120 are communicatively connected to each other via a communication network 130. In addition, each power router 120 is connected to one or more other power routers 120 in a power transmittable and receivable manner by a power transmission line 140.

Here, a flow route of electric power formed by the two power routers 120 being connected to each other is called a power transmission and distribution section. For example, power routers i and j are connected to each other by a power transmission line, and thereby a power transmission and distribution section (i, j) is formed. In other words, the power transmission and distribution section (i, j) is a concept including the power routers i and j, and the power transmission line. In addition, a flow route of electric power from the power router 120 of a power transmission source to the power router 120 of a power transmission destination via one or more power transmission and distribution sections is called a power transmission and distribution route.

The controller 110 is a device that controls power transmission of electric power among the plurality of power routers 120. The controller 110 has a risk information acquisition unit 111 and a control instruction generation unit 112.

The risk information acquisition unit 111 acquires risk information, which is the information used to calculate a fault occurrence risk in the power transmission and distribution section.

The control instruction generation unit 112 decides a power transmission and distribution route and transmission and distribution energy between the power routers 120 of the power transmission source and the power transmission destination using the risk information acquired by the risk information acquisition unit 111, and transmits a control instruction to the power router 120.

The power router 120 is a device that transmits and receives electric power to/from the other power routers 120 in accordance with the control instruction received from the controller 110. The power router 120 has a transmitting and receiving unit 121 and a transmitting and receiving control unit 122.

The transmitting and receiving unit 121 has a function to transmit electric power received from the transmitting and receiving unit 121 of the other power router 120 to the transmitting and receiving unit 121 of the still other power router 120. Specifically, the transmitting and receiving unit 121 includes one or more power input terminals and one or more power output terminals, and outputs electric power input from the one or more power input terminals to the one or more designated power output terminals just as much as designated electric power, respectively.

The transmitting and receiving control unit 122 receives the control instruction that the control instruction generation unit 112 of the controller 110 transmit. The transmitting and receiving control unit 122 performs control for the transmitting and receiving unit 121 in accordance with the control instruction. The transmitting and receiving unit 121 transmits electric power. Specifically, the transmitting and receiving control unit 122 makes the power router of a power transmission and distribution destination included in the described control instruction transmits transmission and distribution energy included in the above-described control instruction.

Subsequently, processing performed by the power transmission and distribution system 100 will be explained using FIGS. 2 to 3. The power transmission and distribution system 100 executes: (1) calculation processing of risk scores of power transmission and distribution sections based on risk information; (2) decision processing of a power transmission and distribution route based on the risk scores; and (3) a control instruction to the power router 120. The above-described processing will be explained in order using a flow chart of FIG. 2.

### (1) Calculation Processing of Risk Score of Power Transmission and Distribution Section Based on Risk Information

S101: Acquisition of Risk Information

The risk information acquisition unit 111 acquires risk information. The risk information is the information on a risk (for example, lightning strike) as a factor that causes a fault in a power transmission and distribution section. The risk information means an occurrence probability of danger, magnitude of damage by danger or information needed to drive them.

The risk information can also include risk information on the power router itself in addition to risk information on a power transmission line

Risk information on the power router itself can also include in the risk information in addition to risk information on a power transmission line configuring the power transmission and distribution section. The risk information is used when the control instruction generation unit 112 calculates a risk score for each power transmission and distribution section.

An example of risk information is shown in FIG. 3. As shown in FIG. 3A, the risk information includes information, such as a type of danger (for example, lightning strike, rain, terrorism, and power theft), an occurrence probability of the danger, a predicted duration time of the danger (for example, a power outage time when the danger occurs), a point (coordinate) where the danger is predicted to occur, and intensity of the danger (a degree of an influence when the danger occurs, for example, a scale of lightning and strength of wind).

In addition, as shown in FIG. 3B, the risk information may be defined for each of regions where a power transmission and distribution section is laid. These regions may be meshes obtained by dividing (or partitioning) one region into a plurality of square or rectangular sections (i.e., meshes). In such cases, the risk information may be defined for each of the meshes. Namely, risk information in a coordinate (X_{A}, Y_{A}) of a representative point included in a mesh A is defined as risk information of the mesh A. Similarly, risk information in a coordinate (X_{B}, Y_{B}) of a representative point included in a mesh B is defined as risk information of the mesh B. Similarly, risk information is defined for all the meshes.

The risk information acquisition unit 111 receives risk information from an external computer system etc. (for example, an information service system of a weather forecast company) for each certain time or whenever new danger is predicted, and thereby can acquire the risk information. Alternatively, the risk information acquisition unit 111 may acquire the risk information by referring to risk information previously stored in memory means, which is not shown.

S102: Calculation of Risk Score

The control instruction generation unit 112 calculates a risk score of a power transmission and distribution section using the risk information acquired by the risk information acquisition unit 111. Here, the risk score is a value for quantitatively indicating a risk of the power transmission and distribution section formed by the two power routers 120 being connected to each other.

When the power router 120 of the power transmission source and the power router 120 of the power transmission destination are previously decided, the control instruction generation unit 112 calculates a risk score of each of a plurality of power transmission and distribution sections through which electric power can pass in the electric power being transmitted from the power transmission source to the power transmission destination. Alternatively, the control instruction generation unit 112 may calculate risk scores of all power transmission and distribution sections formed by all the power routers 120 connected to the controller 110.

A calculation method of the risk score can be variously determined based on an operation policy of the power transmission and distribution system 100. Here, several examples of calculation methods of the risk score are disclosed as one example.

### [1] Calculation of Risk Score Based on Risk Information and Predetermined Calculation Formula

The power transmission line 140 that configures the power transmission and distribution section (i, j) formed by the power routers i and j being connected to each other is assumed to be laid on one or more meshes. At this time, the control instruction generation unit 112 calculates by Formula 1 a risk score

r_{i,j}^{m}

of each of meshes m where the power transmission and distribution section (i, j) is laid.

$${r}_{i , j}^{m} = {\sum }_{k} {q}_{i , j}^{m , k} {t}_{i , j}^{m , k} \qquad [ Formula 1 ]$$

Here,

R_{i,j}^{m}

is the risk score of the power transmission and distribution section (i, j) in the focused-on mesh m. In addition,

q_{i,j}^{m,k}

is an occurrence probability of a risk k in the focused-on mesh m, and

t_{i,j}^{m,k}

is a predicted duration time of the risk k.

If calculating the risk scores

r_{i,j}^{m}

of all the meshes m through which the power transmission and distribution section (i, j) passes, the control instruction generation unit 112, for example, decides a maximum value in those risk scores as a risk score r_{i,j} of the power transmission and distribution section (i, j).

### [2] Calculation of Risk Score Based on Risk Information and Database

The memory of the power transmission and distribution system 100, not shown in figure, may retain a database that risk information (particularly an occurrence probability of a risk, a predicted duration time of the risk, etc.) and risk scores correspond to each other. In this case, the control instruction generation unit 112 can specify the risk scores

r_{i,j}^{m}

of all the meshes through which the power transmission and distribution section (i, j) passes with reference to the database. After that, for example, a maximum value in those risk scores can be decided as the risk score r_{i,j} of the power transmission and distribution section (i, j).

### [3] Calculation of Risk Score to Which Amount of Damage Has Been Added

The control instruction generation unit 112 may calculate a new risk score r_{i,j}, for example, by a function having as elements the risk scores calculated using the above-described [1] or [2], and damage (for example, energy multiplied by a power unit price) that occurs at an endpoint (a load to use electric power transmitted via the power transmission and distribution section (i, j)) by break of the power transmission and distribution section (i, j).

### (2) Decision Processing of Power Transmission and Distribution Route Based on Risk Score

S103: Decision of Power Transmission and Distribution Route

Next, the control instruction generation unit 112 decides a power transmission and distribution route using the risk score r_{i,j} of each power transmission and distribution section (i, j) calculated by (1). Namely, the control instruction generation unit 112 decides one or more power transmission and distribution sections through which electric power should pass from the source power router 120 of the power transmission to the destination power router 120 of the power transmission.

As one example, the embodiment 1 discloses a method for deciding a power transmission and distribution route in which a total risk score is a minimum.

The control instruction generation unit 112 decides the power transmission and distribution route in which the total risk score is a minimum by solving an optimization problem for an objective function of Formula 2. Specifically, the power transmission and distribution route in which the total risk score is the minimum is fixed by solving the following optimization problem.

$$\begin{matrix}[ Formula 2 ] & \\ Minimize \text{:} {\sum }_{1 \leq i \leq N} {\sum }_{1 \leq j \leq N} {r}_{i , j} {p}_{i , j} & ( 1 ) \\ subject to \text{:} & \\ {\sum }_{1 \leq j \leq N} {p}_{i , j} = {\sum }_{1 \leq j \leq N} {p}_{i , j} , \\ for \\ i = 1 , 2 , … , N & ( 2 ) \\ 0 \leq {p}_{i , j} \leq {C}_{i , j} , \\ for \\ i = 1 , 2 , … , N , \\ j = 1 , 2 , … , N & ( 3 )\end{matrix}$$

Here, N indicates the total number of power routers, r_{i,j} indicates a risk score of a certain power transmission and distribution section (i, j), p_{i,j} indicates passing power from the power router i to the power router j in the power transmission and distribution section (i, j), and C_{i,j} indicates a power transmission capacity of the power transmission and distribution section (i, j). r_{i,j} can be calculated by Expression (1). Expression (1) represents an objective function that minimizes a risk in power transmission and distribution. Expressions (2) and (3) represent constraints. Expression (2) represents that a total sum of input power and a total of output power in each power router are equal to each other. Expression (3) represents that magnitude of electric power in each power transmission and distribution section is not less than zero and not more than the power transmission capacity.

As a specific method for solving the above-described optimization problem, there is included a method utilizing a well-known algorithm, such as a simplex method for solving a linear programming problem. As a result of solving the optimization problem, a specified combination of p_{i,j} indicates the power transmission and distribution route in which the total risk score is the minimum.

### (3) Control Instruction to Power Router 120

S104: Transmission of Control Instruction

The control instruction generation unit 112 transmits a control instruction to the power router 120 located on the power transmission and distribution route decided by (2) through the communication network 130. Information to specify the other power router 120 that the power router 120 should transmit electric power, and energy that should be transmitted is included in the control instruction.

The transmitting and receiving control unit 122 of the power router 120 receive the control instruction. The transmitting and receiving control unit 122 performs control to the transmitting and receiving unit 121 for executing power transmission in accordance with the control instruction. Namely, the transmitting and receiving control unit 122 control the transmitting and receiving unit 121 to transmit the energy included in the above-described control instruction to the power router of the power transmission and distribution destination included in the control instruction.

According to the embodiment, the control instruction generation unit 112 calculates the risk score for each power transmission and distribution section based on the risk information acquired by the risk information acquisition unit 111, and a most suitable power transmission and distribution route is decided based on the risk scores.

Consequently, an appropriate power transmission and distribution route according to the risk can be decided.

### Embodiment 2

In the embodiment 1, basically, the power router 120 is optimized so as to output all electric power through the power transmission and distribution section having a smaller risk score. in case where there are a plurality of power transmission and distribution sections that can output electric power from a certain power router 120, and any power transmission and distribution section is included in the power transmission and distribution route. However, there is a case where electric power is desirably distributed into the plurality of power transmission and distribution sections instead of being distributed into either one of the power transmission and distribution sections depending on an operation policy of the power transmission and distribution system 100. Consequently, a configuration for appropriately distributing electric power into a plurality of power transmission and distribution sections according to a risk score is disclosed in an embodiment 2.

The power transmission and distribution system 100 according to the embodiment 2 is characterized by a processing content of S103 of FIG. 2: decision of power transmission and distribution route. Other configurations, processing, etc. are similar to the embodiment 1 unless otherwise explained.

Decision processing of a power transmission and distribution route in the embodiment 2 is shown hereinafter.

### S103: Decision of Power Transmission and Distribution Route

The control instruction generation unit 112 performs processing to decide the power transmission and distribution route using the risk scores of the power transmission and distribution section calculated by (1) of the embodiment 1. Namely, the control instruction generation unit 112 decides one or more power transmission and distribution sections through which electric power should pass from the power router 120 of the power transmission source to the power router 120 of the power transmission destination.

A decision method of the power transmission and distribution route based on a virtual power transmission capacity is disclosed in the embodiment 2.

First, the control instruction generation unit 112 calculates a virtual power transmission capacity C_{i,j}′ of each power transmission and distribution section (i, j).

The virtual power transmission capacity C_{i,j}′ is a virtual power transmission capacity defined separately from an actual power transmission capacity C_{i,j} of the power transmission and distribution section (i, j). The virtual power transmission capacity C_{i,j}′ can be, for example, calculated by Formula 3.

$${C}_{i , j}^{′} = {C}_{i , j} f ( {a}_{i} ) \\ {a}_{i , j} = 1 - {r}_{i , j} / {\sum }_{1 \leq i \leq N}^{ } {\sum }_{1 \leq j \leq N} \\ where \\ 0 \leq f ( {x}_{1 } ) \leq f ( {x}_{2} ) \leq 1 , {x}_{1} ∈ [ 0 , 1 ] , {x}_{2} ∈ [ 0 , 1 ] , {x}_{1} < {x}_{2} \qquad [ Formula 3 ]$$

Here, C_{i,j} indicates the power transmission capacity of the power transmission and distribution section (i, j), and C_{i,j}′ indicates the virtual power transmission capacity. r_{i,j} indicates a risk score of the power transmission and distribution section (i, j). In addition, f(x) may be, for example, x, x², x³, x⁴, . . . , and xⁿ.

The embodiment is characterized in that the virtual power transmission capacity C_{i,j}′ of the power transmission and distribution section (i, j) is calculated based on the risk score r_{i,j} of the same section as described above.

Next, the control instruction generation unit 112 decides an amount of transmission and distribution power in each power transmission and distribution section by solving the following optimization problem based on a virtual power transmission capacity of each of the plurality of power transmission and distribution sections.

$$\begin{matrix}[ Formula 4 ] & \\ Minimize \text{:} {\sum }_{1 \leq i \leq N} {\sum }_{1 \leq j \leq N} {r}_{i , j} {p}_{i , j} & ( 1 ) \\ subject to \text{:} & \\ {\sum }_{1 \leq j \leq N} {p}_{i , j} = {\sum }_{1 \leq j \leq N} {p}_{i , j} , \\ for \\ i = 1 , 2 , … , N & ( 2 ) \\ 0 \leq {p}_{i , j} \leq {C}_{i , j} , \\ for \\ i = 1 , 2 , … , N , \\ j = 1 , 2 , … , N & ( 3 )\end{matrix}$$

Here, N indicates the total number of power routers, r_{i,j} indicates a risk score of a certain power transmission and distribution section (i, j), p_{i,j} indicates passing power from the power router i to the power router j in the power transmission and distribution section (i, j), and C_{i,j}′ indicates a virtual power transmission capacity of the power transmission and distribution section (i, j). Expression (1) represents an objective function that minimizes the risk in power transmission and distribution. Expressions (2) and (3) represent constraints. Expression (2) represents that a total sum of input power and a total of output power in each power router are equal to each other. Expression (3) represents that magnitude of electric power in each power transmission and distribution section is not less than zero and not more than the virtual power transmission capacity.

As a specific method for solving the above-described optimization problem, there is included a method utilizing a well-known algorithm, such as the simplex method for solving the linear programming problem. As a result of solving the optimization problem, a specified combination of p_{i,j} indicates the power transmission and distribution route in which the total risk score is the minimum. Namely, the power transmission and distribution route formed in case where is transmitted via the power transmission and distribution section (i, j) is an objective power transmission and distribution route.

### S104: Transmission of Control Instruction

The control instruction generation unit 112 transmits a control instruction to the power router 120 located on the power transmission and distribution route decided based on the virtual power transmission capacity via the communication network 130. Information to specify the other power router 120 that the power router 120 should transmit electric power, and energy that should be transmitted is included in the control instruction.

The transmitting and receiving control unit 122 of the power router 120 that has received the control instruction performs control to the transmitting and receiving unit 121 for executing power transmission in accordance with the control instruction. Namely, the transmitting and receiving control unit 122 control the transmitting and receiving unit 121 to transmit energy included in the above-described control instruction to the power router of the power transmission and distribution destination included in the control instruction.

According to the embodiment, the control instruction generation unit 112 calculates virtual power transmission capacities of the plurality of power transmission and distribution sections based on the risk scores, and calculates amounts of transmission and distribution power based on the virtual power transmission capacities. Consequently, the energy according to the risk score can be distributed into the plurality of power transmission and distribution sections. Consequently, detailed route setting according to the operation policy of the power transmission and distribution system 100 can be achieved.

For example, as shown in the embodiment 1, when power transmission and distribution is alternatively performed to one power transmission and distribution section even when the plurality of power transmission and distribution sections are present, and as a result, power transmission and distribution is performed by one power transmission and distribution route, all power transmission to the endpoint stops if a fault occurs in the power transmission and distribution route. Meanwhile, as shown in the embodiment 2, when electric power is distributed into the plurality of power transmission and distribution sections, and power transmission and distribution to the endpoint is performed by the plurality of power transmission and distribution routes, an effect on the endpoint can be suppressed even if the fault occurs in any of power transmission and distribution routes.

As described above, according to the embodiment, choices for performing flexible route setting according to various operation policies can be provided.

### Other Embodiment

Note that the present invention is not limited only to the above-mentioned embodiments, and that it is needless to say that various changes can be made without departing from the scope of the present invention.

For example, although the specific formulas for calculating the risk scores and deciding the power transmission and distribution route have been shown in the above-mentioned embodiments, the present invention is not necessarily limited to these, and the risk scores can be calculated by various methods according to operation policies, and the power transmission and distribution route can be decided.

In addition, in the above-mentioned embodiments, the present invention has been explained on the premise that the risk information is constant regardless of a period of time. However, risk information may be changed according to the period of time. For example, one day may be divided into a plurality of periods of time T, and risk information may be defined for each of these periods of time T. In this case, for example, a risk score is calculated as a risk score in the period of time T, a virtual power transmission capacity is as a virtual power transmission capacity therein, and a power transmission and distribution route is as a power transmission and distribution route therein. Calculation of a route for performing power transmission and distribution in the period of time T is preferably executed by a period of time (T−n), n∈N, i.e., before the period of time T comes.

In addition, although the present invention has been explained mainly as a hardware configuration in the above-mentioned embodiments, it is not limited to this, and it is also possible to achieve arbitrary processing by making a CPU (Central Processing Unit) execute a computer program. In this case, the computer program is stored using various types of non-transitory computer readable media, and can be supplied to a computer. The non-transitory computer readable media include various types of tangible storage media. Examples of the non-transitory computer readable medium include: a magnetic recording medium (for example, a flexible disk, a magnetic tape, a hard disk drive); a magnetic optical recording medium (for example, a magnetic optical disk); a CD-ROM (Read Only Memory); a CD-R; a CD-R/W; and a semiconductor memory (for example, a mask ROM, a PROM (Programmable ROM), an EPROM (Erasable PROM), a flash ROM, an RAM (random access memory)). In addition, the program may be supplied to the computer by various types of transitory computer readable media. Examples of the transitory computer readable medium include an electrical signal, an optical signal, and an electromagnetic wave. The transitory computer readable medium can supply the program to the computer through a wired communication channel, such as a power line and an optical fiber, or a wireless communication channel.

Hereinbefore, although the invention in the present application has been explained with reference to the embodiments, the invention in the present application is not limited by the above. Various changes that can be understood by those skilled in the art within the scope of the invention can be made to a configuration and a detail of the invention in the present application.

This application claims priority based on Japanese Patent Application No. 2012-202915 filed on Sep. 14, 2012, and the entire disclosure thereof is incorporated herein.

### REFERENCE SIGNS LIST

100 power transmission and distribution system

110 controller

111 risk information acquisition unit

112 control instruction generation unit

120 power router

121 transmitting and receiving unit

122 transmitting and receiving control unit

130 communication network

140 power transmission line

1. A power transmission and distribution system comprising:
a plurality of power routers that can output input electric power to one or more designated output destinations just as much as designated electric power, respectively; and
a controller that controls the power routers, wherein
the controller has:
risk information acquisition unit that acquires risk information on a power transmission and distribution section formed by the two power routers being connected to each other; and
control instruction unit that calculates a risk score of the power transmission and distribution section based on the risk information, deciding a power transmission and distribution route including the one or more power transmission and distribution sections based on the risk score, and transmitting a control instruction based on the power transmission and distribution route to the power router, and
the power router has:
transmitting and receiving unit that outputs input electric power to the one or more power transmission and distribution sections; and
transmitting and receiving control unit that controls the output of the transmitting and receiving unit according to the control instruction.

2. The power transmission and distribution system according to claim 1, wherein when a plurality of the power transmission and distribution routes can be present, the control instruction unit decides as the power transmission and distribution route that should be used the power transmission and distribution route in which a total sum of risk scores of the power transmission and distribution sections included in the power transmission and distribution route is a minimum.

3. The power transmission and distribution system according to claim 1, wherein the control instruction unit decides a power transmission and distribution route so that the one power router outputs electric power to the plurality of power transmission and distribution sections in a distributed manner according to the risk scores of the respective power transmission and distribution sections.

4. The power transmission and distribution system according to claim 3, wherein the control instruction unit calculates virtual power transmission capacities of the respective plurality of power transmission and distribution sections according to the risk scores, and calculates distribution amounts of electric power into the plurality of power transmission and distribution sections based on the virtual power transmission capacities.

5. A controller that controls a plurality of power routers that can output input electric power to one or more designated output destinations just as much as designated electric power, respectively,
wherein the controller has:
risk information acquisition unit that acquires risk information on a power transmission and distribution section formed by the two power routers being connected to each other; and
control instruction unit that calculates a risk score of the power transmission and distribution section based on the risk information, deciding a power transmission and distribution route including the one or more power transmission and distribution sections based on the risk score, and transmitting a control instruction based on the power transmission and distribution route to the power router.

6. A power router that can output input electric power to one or more designated output destinations just as much as designated electric power, respectively, the power router comprising:
transmitting and receiving unit that outputs input electric power to the one or more power transmission and distribution sections; and
transmitting and receiving control unit that receives a control instruction from a controller and controlling the output of the transmitting and receiving unit,
wherein the control instruction is generated by the controller based on a power transmission and distribution route, after the controller:
acquires risk information on a power transmission and distribution section formed by the two power routers being connected to each other;
calculates a risk score of the power transmission and distribution section based on the risk information; and
decides the power transmission and distribution route including the one or more power transmission and distribution sections based on the risk score.

7. A power transmission and distribution method, comprising:
a risk information acquisition step in which a controller acquires risk information on a power transmission and distribution section formed by two power routers being connected to each other;
a risk score calculation step in which the controller calculates a risk score of the power transmission and distribution section based on the risk information;
a power transmission and distribution route decision step in which the controller decides a power transmission and distribution route including the one or more power transmission and distribution sections based on the risk score;
a control instruction step in which the controller transmits a control instruction based on the power transmission and distribution route to the power router; and
a transmitting and receiving step in which the power router outputs electric power input to the power router to the one or more designated power transmission and distribution sections just as much as designated electric power according to the control instruction, respectively.

8. A non-transitory computer readable medium storing a program that makes a computer execute:
a risk information acquisition step of acquiring risk information on a power transmission and distribution section formed by two power routers being connected to each other;
a risk score calculation step of calculating a risk score of the power transmission and distribution section based on the risk information;
a power transmission and distribution route decision step of deciding a power transmission and distribution route including the one or more power transmission and distribution sections based on the risk score;
a control instruction step of generating a control instruction based on the power transmission and distribution route; and
a transmitting and receiving step of outputting electric power input to the power router to the one or more designated power transmission and distribution sections just as much as designated electric power according to the control instruction, respectively.

9. A non-transitory computer readable medium storing a program that makes a computer execute:
a risk information acquisition step of acquiring risk information on a power transmission and distribution section formed by two power routers being connected to each other;
a risk score calculation step of calculating a risk score of the power transmission and distribution section based on the risk information;
a power transmission and distribution route decision step of deciding a power transmission and distribution route including the one or more power transmission and distribution sections based on the risk score; and
a control instruction step of generating a control instruction based on the power transmission and distribution route.

10. A non-transitory computer readable medium storing a program that makes a computer execute:
a step of receiving from a controller a control instruction generated by controller based on a power transmission and distribution route, after the controller acquires risk information on a power transmission and distribution section formed by the two power routers being connected to each other, calculates a risk score of the power transmission and distribution section based on the risk information, and decides the power transmission and distribution route including the one or more power transmission and distribution sections based on the risk score; and
